(19) United States
(12) Patent Application Publication
(10) Pub. No.: US 2009/0009462 A1
(43) Pub. Date: Jan. 8, 2009

(54) LIQUID CRYSTAL DISPLAY PANEL AND DRIVING METHOD THEREOF

(75) Inventors: Chao-Ching Hsu, Hsinchu (TW); Cheng-Liang Ma, Hsinchu (TW); Wei-cheng Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 11/853,026

(22) Filed: Sep. 11, 2007

(30) Foreign Application Priority Data
Jul. 4, 2007 (TW) 96124334

(51) Int. Cl. G09G 3/36

(52) U.S. Cl. 345/99

(57) ABSTRACT

An LCD panel including a liquid crystal cell array, gate driving integrated circuits (ICs), first source driving ICs, second source driving ICs and a timing control circuit is provided. The liquid crystal cell array has a first display area and a second display area. The first and the second source driving ICs are electrically connected with the first and the second display areas, respectively, while the timing control circuit is electrically connected with the source and the gate driving ICs. The LCD panel is driven by writing data into the first display area through the first source driving ICs via a first receiving/transmitting mode and writing data into the second display area through the second source driving ICs via a second receiving/transmitting mode. The first data receiving/transmitting mode is different from the second receiving/transmitting mode.

### CROSS-REFERENCE TO RELATED APPLICATION

This application claims the priority benefit of Taiwan application serial no. 96124334, filed Jul. 4, 2007. All disclosure of the Taiwan application is incorporated herein by reference.

### BACKGROUND OF THE INVENTION

1. Field of the Invention

The present invention relates to a liquid crystal display (LCD) panel and a driving method thereof, and more particularly to a display panel having source driving integrated circuits (ICs) with different data receiving/transmitting modes and a driving method thereof.

2. Description of Related Art

With great advance in techniques of manufacturing optoelectronics and semiconductor devices, flat panel displays have been vigorously developed. Among the flat panel displays, LCDs characterized by low operating voltage, free of harmful radiation, light weight and small and compact size gradually replace conventional CRT displays and have become mainstream display products. In addition, with the features of low power consumption, lightness and compactness, the LCDs are more extensively applied to portable personal electronic devices. Hence, fabricating a lighter, thinner, and more power-saving LCD is currently an essential issue which draws attention of display manufacturers.

FIG. 1 is a schematic view of a conventional LCD panel. Referring to FIG. 1, a conventional LCD 100 includes a display panel 110, a plurality of source driving ICs SD0˜SDm, a plurality of gate driving ICs GD0˜GDn, and a printed circuit board 120. Here, m and n are positive integers. A plurality of pixels (not shown) is disposed on the display panel 110. The printed circuit board 120 has a control circuit 121 and is disposed over the display panel 110. Through a flexible printed circuit 123, the printed circuit board 120 is electrically connected to the display panel 110. Data signals generated by the control circuit 121 are transmitted to the source driving ICs SD0˜SDm via the flexible printed circuit 123. In addition, the source driving ICs SD0˜SDm are coupled in series and usually transmit data in a one-way direction. Therefore, after the first source driving IC SDO completes a retrieval of the data signals, the remained data signals pass through the first source driving IC SD0 to the second source driving IC SD1. Thereafter, the second source driving IC SD1 retrieves the data signals, and a next source driving IC SD2 then retrieves the remained data signals after the second source driving IC SD1 has finished the retrieval of the data signals. According to said order, the data are written into the pixels by all the source driving ICs SD0˜SDm after the last source driving IC SDm completes the retrieval of the data signals. It is known from FIG. 1 that the flexible printed circuit 123 has to be disposed at a corner of the display panel 110 in most cases, so as to connect the first source driving IC SD0. Therefore, designers are not able to further reduce a length of the printed circuit board 120.

Moreover, based on actual demands, the printed circuit board 120 may be disposed over or under the display panel 110. All of the source driving ICs SD0˜SDm are in the same data receiving/transmitting mode (a mode which bypasses data after receiving an assigned data). Thus, given that the printed circuit board 120 previously disposed over the display panel 110 is alternatively positioned under the display panel 110, images are then displayed by the display panel 110 in left-and-right reverse manner. At this time, the designers have to additionally dispose a line buffer on the printed circuit board 120 to temporarily store all of the data signals. After that, the stored data signals are outputted to the source driving ICs SD0˜SDm in a reverse order. In view of the above, the LCDs 100 with various designs are able to share the same printed circuit board 120. Nevertheless, additional disposition of the line buffer on the printed circuit board 120 not only results in an increase in the entire power consumption of the LCD 100, but also raises the manufacturing costs.

### SUMMARY OF THE INVENTION

The present invention is directed to an LCD panel having source driving ICs with different data receiving/transmitting modes.

The present invention is further directed to a driving method by which source driving ICs are able to drive an LCD panel via different data receiving/transmitting modes, so as to reduce power consumption.

The present invention provides an LCD panel including a liquid crystal cell array, a plurality of gate driving ICs, a plurality of first source driving ICs, a plurality of second source driving ICs and a timing control circuit. The liquid crystal cell array has a first display area and a second display area. The first and the second display areas further include a plurality of scan lines, a plurality of data lines and a plurality of pixel units, and each of the pixel units is electrically connected to one corresponding scan line and one corresponding data line. In addition, the gate driving ICs are electrically connected to the scan lines, whereas the first and the second source driving ICs are electrically connected to the data lines in the first and the second display areas, respectively. The first source driving ICs transmit and receive data through a first data receiving/transmitting mode, while the second source driving ICs transmit and receive the data through a second data receiving/transmitting mode. Besides, the timing control circuit is electrically connected to the gate driving ICs and the source driving ICs.

According to an embodiment of the present invention, the first data receiving/transmitting mode is a mode which bypasses data before receiving an assigned data, while the second data receiving/transmitting mode is a mode which bypasses data after receiving an assigned data.

According to an embodiment of the present invention, the first source driving ICs and the second source driving ICs are flip-chip packages or tape carrier packages (TCPs). In other words, the first source driving ICs and the second source driving ICs are connected to the data lines through a chip-on-glass (COG) technology or a tape automated bonding (TAB) technology.

According to an embodiment of the present invention, a data transmission direction of the first receiving/transmitting mode is in reverse to a data transmission direction of the second receiving/transmitting mode.

According to an embodiment of the present invention, before data signals are about to be temporarily stored, each of the first source driving ICs outputs a first control signal to a next first source driving IC.

According to an embodiment of the present invention, before data signals are about to be temporarily stored, each of the second source driving ICs outputs a second control signal to a next second source driving IC.

According to an embodiment of the present invention, the first source driving ICs which have completed a temporary storage of data signals stop receiving timing control signals provided by the timing control circuit.

According to an embodiment of the present invention, the second source driving ICs which have not started to retrieve data signals temporarily receive no timing control signals provided by the timing control circuit.

According to an embodiment of the present invention, the first and the second source driving ICs respectively have a register for temporarily storing data signals.

According to an embodiment of the present invention, the LCD panel may further include a flexible printed circuit electrically connected to the timing control circuit and a part of the source driving ICs. According to a preferred embodiment of the present invention, the flexible printed circuit is electrically connected to the first source driving IC closest to the second display area and is electrically connected to the second source driving IC closest to the first display area.

According to an embodiment of the present invention, the flexible printed circuit is disposed at an intersection of the first display area and the second display area.

The present invention further provides a driving method adapted to drive an LCD panel having a first display area and a second display area. The LCD panel includes a plurality of gate driving ICs, a plurality of first source driving ICs, and a plurality of second source driving ICs. The first and the second source driving ICs are electrically connected to the first and the second display areas, respectively. The driving method of the present invention includes the following steps. First, data are respectively written into the first and the second display areas in sequence through the first and the second source driving ICs via a first receiving/transmitting mode and a second receiving/transmitting mode. Here, the first data receiving/transmitting mode is a mode which bypasses data before receiving an assigned data, while the second data receiving/transmitting mode is a mode which bypasses data after receiving an assigned data Besides, a data transmission direction of the first receiving/transmitting mode is in reverse to a data transmission direction of the second receiving/transmitting mode.

According to an embodiment of the present invention, before data signals are about to be temporarily stored, each of the first source driving ICs outputs a first control signal to a next first source driving IC.

According to an embodiment of the present invention, before data signals are about to be completely retrieved, each of the second source driving ICs outputs a second control signal to a next second source driving IC.

According to an embodiment of the present invention, the first source driving ICs which have completed a temporary storage of data signals stop receiving timing control signals provided by the timing control circuit.

According to an embodiment of the present invention, the second source driving ICs which have not started to retrieve data signals temporarily receive no timing control signals provided by the timing control circuit.

In the present invention, the data signals are temporarily stored in the first data receiving/transmitting mode and the second data receiving/transmitting mode. Hence, it is not required in the present invention to additionally dispose the line buffer in the timing control circuit for temporarily storing the data signals. As such, the reverse images caused by positional changes of the printed circuit board can be avoided. Moreover, the manufacturing costs and the power consumption of the LCD panel can be effectively reduced in the present invention.

In order to the make the aforementioned and other objects, features and advantages of the present invention comprehensible, several embodiments accompanied with figures are described in detail below.

### BRIEF DESCRIPTION OF THE DRAWINGS

FIG. 1 is a schematic view of a conventional LCD panel.

FIG. 2 is a schematic view of an LCD panel according to an embodiment of the present invention.

FIGS. 3A and 3B are flowcharts illustrating steps of a first data receiving/transmitting mode and a second data receiving/transmitting mode.

FIGS. 4A through 4G are schematic views illustrating data transmission according to a present embodiment.

FIG. 5 is a schematic view illustrating a first and a second source driving ICs.

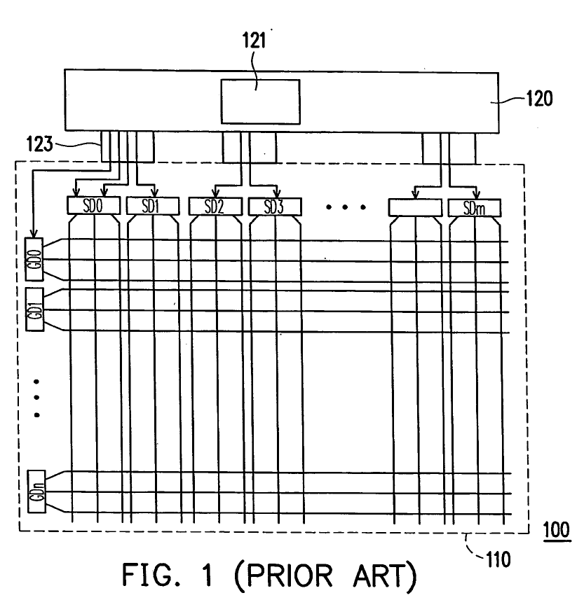

### DESCRIPTION OF EMBODIMENTS

In order for one skilled in the art to more clearly understand technical features of the present invention, it is defined in the following embodiments that the LCD panel has a WXGA specification in conformity to the Video Electronics Standards Association (VESA) standard, and eight 480-channel bi-directional cascaded source driving ICs are employed. However, the following embodiments are not intended to limit the scope of the present invention.

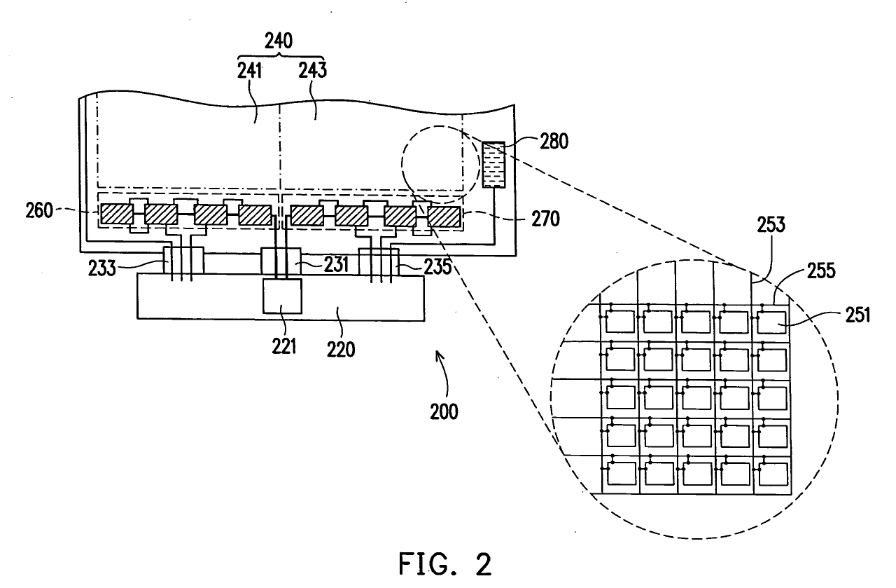

FIG. 2 is a schematic view of an LCD panel according to an embodiment of the present invention. An LCD panel 200 including a liquid crystal cell array 240, a plurality of gate driving ICs 280, a plurality of first source driving ICs 260, a plurality of second source driving ICs 270 and a timing control circuit 221 is provided. The liquid crystal cell array 240 has a first display area 241 and a second display area 243. The first display area 241 and the second display area 243 may occupy substantially identical areas. The first and the second display areas 241 and 243 may further include a plurality of scan lines 255, a plurality of data lines 253 and a plurality of pixel units 251, and each of the pixel units 251 is electrically connected to one corresponding scan line 255 and one corresponding data line 253. Besides, the gate driving ICs 280 are electrically connected to the scan lines 255. The first and the second source driving ICs 260 and 270 are electrically connected to the data lines 253 in the first and the second display areas 241 and 243, respectively. In addition, the timing control circuit 221 is electrically connected to the gate driving ICs 280 and the first and the second source driving ICs 260 and 270 through a flexible printed circuit 231, for example.

Note that the first source driving ICs 260 transmit and receive data through a first data receiving/transmitting mode, while the second source driving ICs 270 transmit and receive the data through a second data receiving/transmitting mode. A data transmission direction of the first receiving/transmitting mode is different from a data transmission direction of the second receiving/transmitting mode.

Moreover, the first source driving ICs 260 and the second source driving ICs 270 may be flip-chip packages or TCPs. In other words, the first source driving ICs 260 and the second source driving ICs 270 are connected to the data lines 253 through a COG technology or a TAB technology.

Referring to FIG. 2, the flexible printed circuit 231 is disposed at an intersection of the first display area 241 and the second display area 243. More particularly, the flexible printed circuit 231 is electrically connected to the first source driving IC 260 closest to the second display area 243 and is electrically connected to the second source driving IC 270 closest to the first display area 241. In the present embodiment, the LCD panel 200 further includes a left flexible printed circuit 233 and a right flexible printed circuit 235, so as to supply a reinforced voltage source to the first source driving ICs 260, the second source driving ICs 270, and the gate driving ICs 290. As such, an RC delay arisen from an excessively far distance at which the voltage source is transmitted to the first and the second source driving ICs 260 and 270 by the middle flexible printed circuit 231 can be prevented, and thus a level of the voltage source is not reduced. The left flexible printed circuit 233 is electrically connected to two first source driving ICs 273 and 275, whereas the right flexible printed circuit 231 is electrically connected to two second source driving ICs 263 and 265.

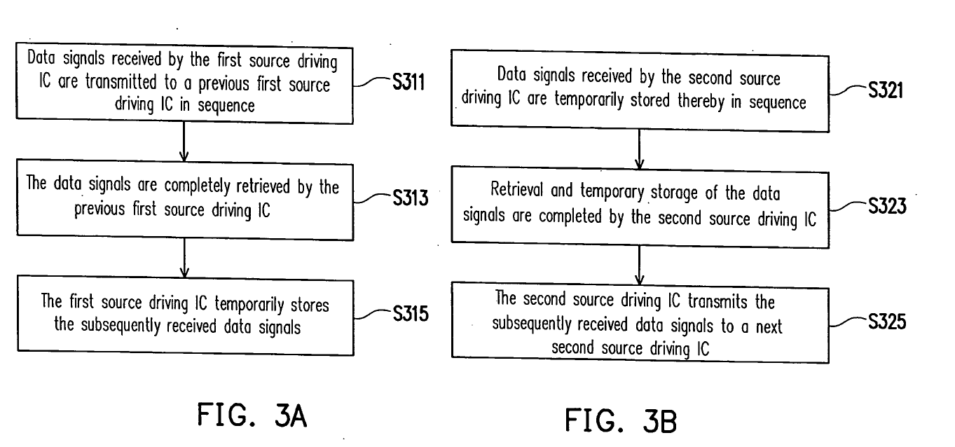

FIGS. 3A and 3B are flowcharts illustrating steps of data transmission in a first data receiving/transmitting mode and a second data receiving/transmitting mode. As illustrated in step S3 11, data signals received by the first source driving IC in the first data receiving/transmitting mode are transmitted to a previous first source driving IC in sequence. In step S313, the data signals are completely retrieved by the previous first source driving IC. In step S315, the first source driving IC starts retrieving and temporarily storing the subsequently received data signals. By contrast, in the second data transmission and receiving mode as shown in step S321, the data signals received by the second source driving IC are temporarily stored thereby in sequence. In step S323, the temporary storage of the data signals in the second source driving IC is completed In step S325, the second source driving IC then transmits the subsequently received data signals to a next second source driving IC.

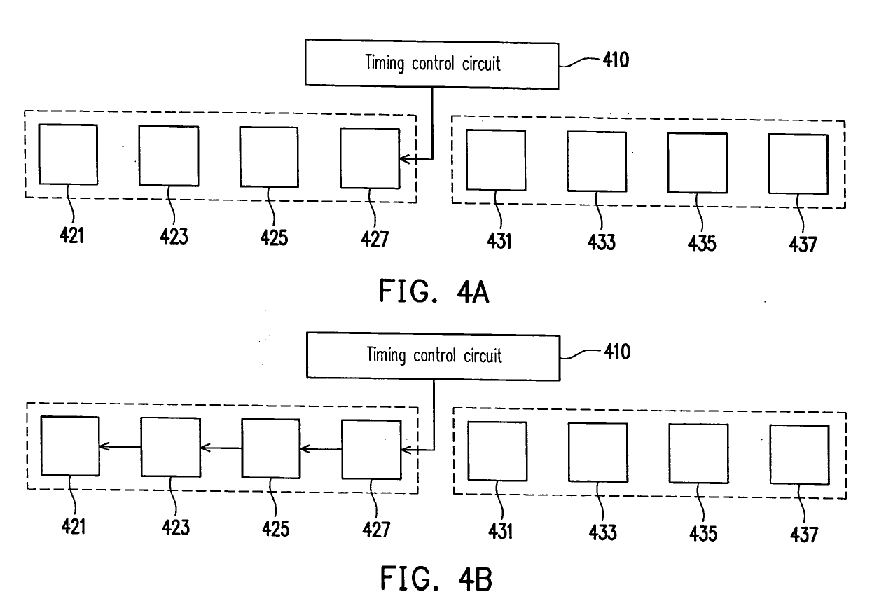

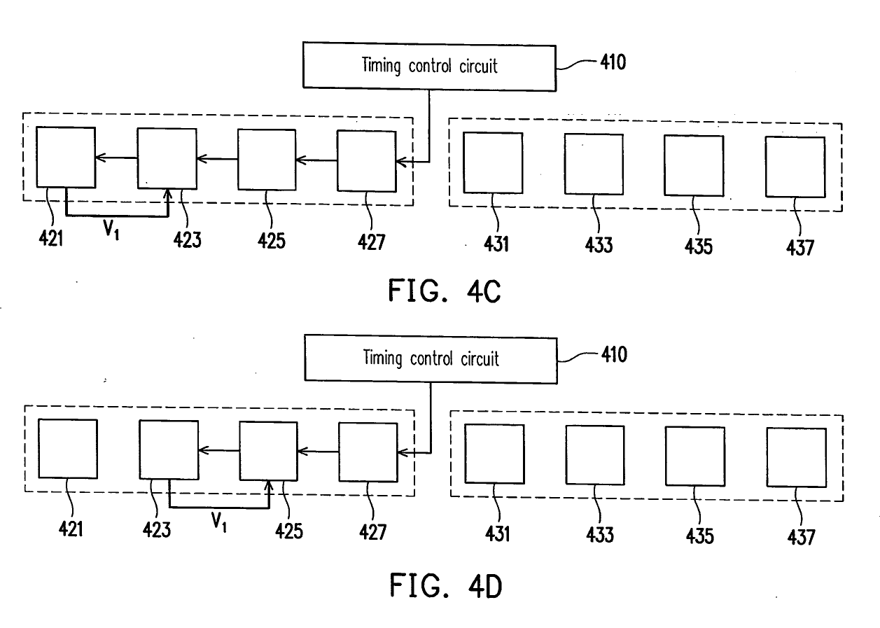

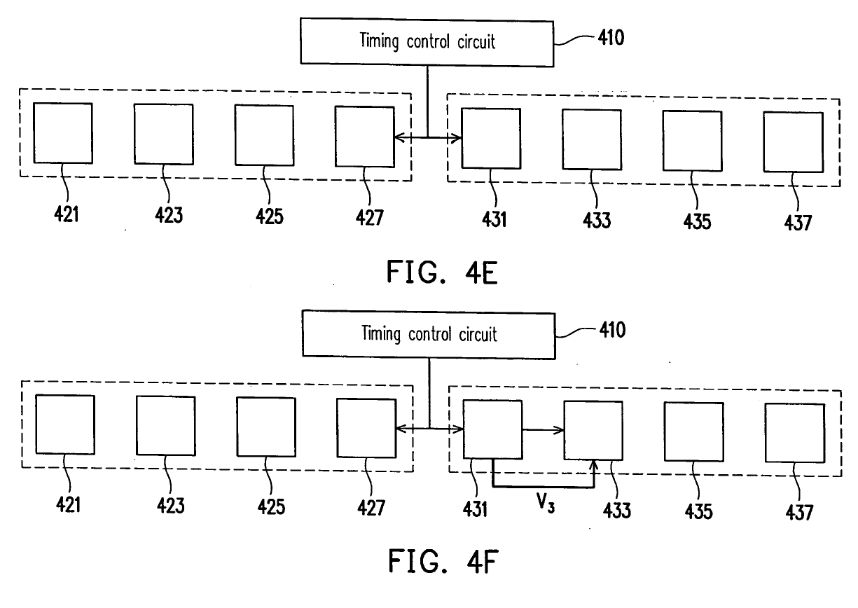

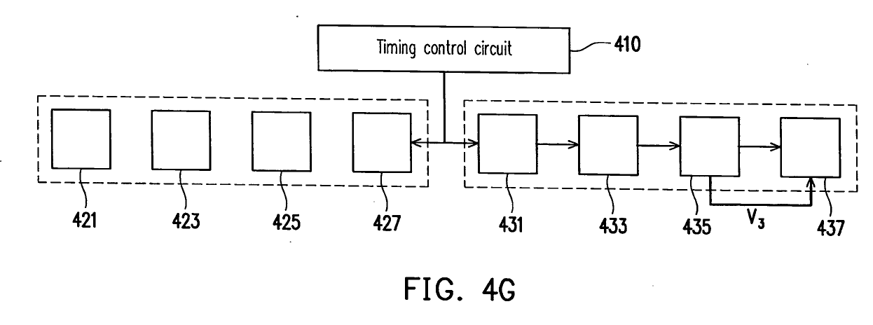

FIGS. 4A through 4G are schematic flowcharts illustrating the data transmission according to the present embodiment. Referring to FIG. 4A, a timing control circuit 410 outputs the data signals and a timing control signal to a first source driving IC 427. Next, referring to FIG. 4B, the first source driving IC 427 sequentially transmits the data signals to first source driving ICs 425, 423 and 421 on the left of the first source driving IC 427. After that, the leftest first source driving IC 421 starts retrieving and temporarily storing the data signals.

Referring to FIG. 4C, as the first source driving IC 421 is about to complete the retrieval of the data signals (e.g. as the 478^{th} data signal or the 479^{th} data signal is retrieved), the first source driving IC 421 outputs a first control signal V1 to the first source driving IC 423, such that the first source driving IC 423 can start preparing the retrieval of the data signals. Thereafter, when the first source driving IC 423 starts retrieving the data signals, it stops outputting the timing control signal and the data signals to the first source driving IC 421. Specifically, the first source driving ICs 421, 423, 425 and 427 which have completed the temporary storage of the data signals do not receive the timing control signal provided by the timing control circuit, and thereby the power consumption of the first source driving ICs 421, 423, 425 and 427 can be reduced.

Please refer to FIG. 4D. Before the data signals are about to be completely retrieved by and temporarily stored in the first source driving IC 423, the first control signal V1 is outputted to the first source driving IC 425, such that the first source driving IC 425 can start preparing the retrieval of the data signals. Afterwards, when the first source driving IC 425 starts retrieving the data signals, it stops outputting the timing control signal and the data signals to the first source driving IC 423. In a similar way, the retrieval of the data signals is then completed by the first source driving IC 427.

It should be noted that second source driving ICs 431, 433, 435 and 437 do not output and receive the timing control signal and the data signals during the data transmission. Thereby, the power consumption of the second source driving ICs 431, 433, 435 and 437 can be reduced.

With reference to FIG. 4E, before the data signals are about to be completely retrieved by and temporarily stored in the first source driving IC 427, the timing control circuit 410 outputs a signal to the second source driving IC 431, such that the second source driving IC 431 starts receiving image signals on the right. As the second source driving IC 431 begins receiving the image signals, the timing control circuit 430 stops outputting the timing control signal and the data signals to the first source driving IC 427 on the left. That is to say, the first source driving ICs 421, 423, 425 and 427 on the left do not receive the timing control signal and the data signals, and thereby the power consumption of the entire LCD panel is decreased.

Next, referring to FIG. 4F, as the second source driving IC 431 is about to complete the retrieval of the data signals (e.g. as the 478^{th} data signal or the 479^{th} data signal is retrieved), the second source driving IC 431 outputs a,second control signal V3 to the second source driving IC 433, such that the second source driving IC 433 can start preparing the retrieval of the data signals. Likewise, as shown in FIG. 4G, the data signals are completely retrieved by and temporarily stored in the second source driving ICs 433, 435 and 437 on the right in the same fashion as discussed above. Since the second source driving ICs 431, 433, 435 and 437 which have not yet started retrieving the data signals do not receive the timing control signal provided by the timing control circuit, the power consumption of the second source driving ICs 431, 433, 435 and 437 can be accordingly reduced.

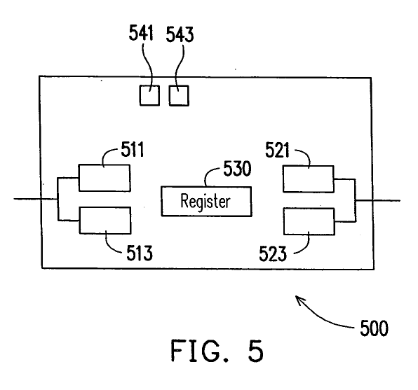

FIG. 5 is a schematic view illustrating a first and a second source driving ICs. Within the first and the second source driving ICs 500, a register 530, a first setting pin 541, a second setting pin 543, a left data receiver 511, a right data receiver 521, a left data transmitter 513, and a right data transmitter 523 are further included.

Referring to FIG. 5, the first and the second setting pins 541 and 543 determine the data receiving/transmitting mode of the first and the second source driving ICs 500. In more detail, the first setting pin 541 determines a direction in which the data signals are transmitted and received. The data signals may be received by the left data receiver 511 and transmitted by the right data transmitter 523, i.e. Left Receive, Right Send. Alternatively, the data signals may be received by the right data receiver 521 and transmitted by the left data transmitter 513, i.e. Right Receive, Left Send. On the other hand, the second setting pin 543 determines an order in which the data signals are transmitted and received. The first and the second source driving ICs 500 may first transmit the received data signals to a previous first and a previous second source driving ICs 500. After the data signals are completely transmitted to the previous first and the previous second source driving ICs 500, the retrieval of the data signals are initiated. That is the first data receiving/transmitting mode. Contrarily, in the second data receiving/transmitting mode, the first and the second source driving ICs 500 may complete the retrieval of the data signals at first, and the subsequently received data signals are then transmitted to a next first and a next second source driving ICs 500.

Furthermore, the register 530 is used to temporarily store the data signals before the retrieval of the data signals are completed by the first and the second source driving ICs 500. The left and the right data transmitters 513 and 523 are electrically connected to the register 530, and so are the left and the right data receivers 511 and 521. In the control of the first setting pin 541, the data receiving/transmitting mode of the first and the second source driving ICs 500 is determined as Left Receive, Right Send or Right Receive, Left Send.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A liquid crystal display (LCD) panel, comprising:
a liquid crystal cell array having a first display area and a second display area, wherein the liquid crystal cell array comprises a plurality of scan lines, a plurality of data lines and a plurality of pixel units, and each of the pixel units is electrically connected to one corresponding scan line and one corresponding data line, respectively;
a plurality of gate driving integrated circuits (ICs) electrically connected to the scan lines;
a plurality of first source driving ICs electrically connected to the data lines in the first display area; a plurality of second source driving ICs electrically connected to the data lines in the second display area, wherein the first source driving ICs transmit and receive data through a first data receiving/transmitting mode, while the second source driving ICs transmit and receive the data through a second data receiving/transmitting mode; and
a timing control circuit electrically connected to the gate driving ICs and the source driving ICs.

2. The LCD panel according to claim 1, wherein the first data receiving/transmitting mode is a mode which bypasses data before receiving an assigned data, while the second data receiving/transmitting mode is a mode which bypasses data after receiving an assigned data.

3. The LCD panel according to claim 1, wherein the first source driving ICs and the second source driving ICs are flip-chip packages or tape carrier packages (TCPs).

4. The LCD panel according to claim 1, wherein a data transmission direction of the first receiving/transmitting mode is in reverse order to a data transmission direction of the second receiving/transmitting mode.

5. The LCD panel according to claim 1, wherein before data signals are about to be temporarily stored, each of the first source driving ICs outputs a first control signal to a next first source driving IC which has not started to retrieve the data signals.

6. The LCD panel according to claim 1, wherein before data signals are about to be temporarily stored, each of the second source driving ICs outputs a second control signal to a next second source driving IC which has not started to retrieve the data signals.

7. The LCD panel according to claim 1, wherein the first source driving ICs which have completed a temporary storage of data signals stop receiving timing control signals provided by the timing control circuit.

8. The LCD panel according to claim 1, wherein the second source driving ICs which have not started to retrieve data signals temporarily receive no timing control signals provided by the timing control circuit.

9. The LCD panel according to claim 1, wherein the first and the second source driving ICs respectively have a register for registering data signals.

10. The LCD panel according to claim 1, further comprising a flexible printed circuit electrically connected to the timing control circuit and a part of the source driving ICs.

11. The LCD panel according to claim 10, wherein the flexible printed circuit is electrically connected to the first source driving IC closest to the second display area and is electrically connected to the second source driving IC closest to the first display area.

12. The LCD panel according to claim 10, wherein the flexible printed circuit is disposed at an intersection of the first display area and the second display area.

13. A driving method adapted to drive an LCD panel having a first display area and a second display area, the LCD panel comprising a plurality of gate driving ICs, a plurality of first source driving ICs connected to the first display area, and a plurality of second source driving ICs connected to the second display area, the driving method comprising:
writing data into the first display area in sequence through the first source driving ICs via a first receiving/transmitting mode; and
writing the data into the second display area in sequence through the second source driving ICs via a second receiving/transmitting mode.

14. The driving method according to claim 13, wherein the first data receiving/transmitting mode is a mode which bypasses data before receiving an assigned data, while the second data receiving/transmitting mode is a mode which bypasses data after receiving an assigned data.

15. The driving method according to claim 13, wherein a data transmission direction of the first receiving/transmitting mode is in reverse order to a data transmission direction of the second receiving/transmitting mode.

16. The driving method according to claim 13, wherein before data signals are about to be temporarily stored, each of the first source driving ICs outputs a first control signal to a next first source driving IC.

17. The driving method according to claim 13, wherein before data signals are about to be completely retrieved, each of the second source driving ICs outputs a second control signal to a next second source driving IC.

18. The driving method according to claim 13, wherein the first source driving ICs which have completed a temporary storage of data signals stop receiving timing control signals provided by the timing control circuit.

19. The driving method according to claim 13, wherein the second source driving ICs which have not started to retrieve data signals temporarily receive no timing control signals provided by the timing control circuit.
